(19) United States
(12) Patent Application Publication
(10) Pub. No.: US 2011/0000111 A1
(43) Pub. Date: Jan. 6, 2011

(54) MARKING EAR LOOP THAT PROMOTES HEALING

(75) Inventors: Jean-Jacques Hilpert, Vitre (FR); Emmanuel Lemaire, Mont d'Origny (FR)

Correspondence Address: YOUNG & THOMPSON, 209 Madison Street, Suite 500, Alexandria, VA, 22314, US

(73) Assignee: ALLFLEX EUROPE SAS, Vitre Cedex (FR)

(21) Appl. No.: 12/812,051

(22) PCT Filed: Dec. 30, 2008
(86) PCT No.: PCT/EP08/68350

§ 371 Date: Sep. 17, 2010

(30) Foreign Application Priority Data
Jan. 8, 2008 (FR) 0800087

(51) Int. Cl. G09F 3/00; A01K 11/00

(52) U.S. Cl. 40/301

(57) ABSTRACT

An auricular label includes a fastening system that combines, with a male part, a female part including a button having an opening and a cavity for receiving the male portion, the button including an essentially cylindrical or frusto-conical head and a circular surface extending in a plane substantially perpendicular to the axis of the head from the base thereof, the loop being characterized in that the surface of the reception button includes at least two perforations ensuring the communication of the lower face of the surface with the atmosphere. The label ensures an improved healing of the insertion point into the ear of the animal, without impairing the rigidity or the solidity of the button, and without permitting the forced extraction of the male part or any other manipulation for forging the data contained in the ring.

This invention relates to the field of marking and identifying animals and more particularly to ear tags for livestock.

It has as its object an ear tag that comprises a system for attachment by an interlocking button and rod, whereby said system comprises aeration openings that make possible enhanced healing from the point of insertion in the animal's ear.

The identification of farm animals was made obligatory in many countries to ensure the monitoring of the livestock's health and to guarantee the traceability of products offered to consumers. This marking relates to cattle as well as to sheep, pigs or goats. The mark generally comprises an identification number that is inscribed on two tags that are attached to the two ears of the animal, which will make it possible to follow them throughout their existence. The crisis due to Mad Cow Disease and its catastrophic implications for the beef market have demonstrated in particular the importance of an effective marking and recording system.

The ear marks made of plastic are currently the most used. They comprise an attachment loop on which all of the legal data are inscribed by printing, engraving, bar code or any other means that is known to one skilled in the art. They are designed to be affixed irreversibly, using an unbreakable attachment system, for example a receiving button that is combined with a rod by irreversible interlocking Their unbreakability results in particular from the impossibility of detaching the male loop from the female loop without destroying one of the two. This imperative is generally ensured by the use of a loop whose top of the female part is a closed shell. By contrast, this fastening presents a drawback: during the affixing of the loop, a small piece of flesh may remain trapped in the closed female top and can cause an infection. Numerous variants have been proposed whose purpose is to improve the solidity and the unbreakability of the attachment system of the loop, to facilitate its affixing through the ear's cartilage and the identification of the data contained in the tag, or else to reduce the production costs thereof.

They should be affixed while the animal is still young and delicate (for calves, for example, the operation is to be done before the age of seven days) and in any case before the marketing of the animal. Several criteria should be met: the way of affixing the loop, the location in the ear, and the healing conditions are essential points for proper handling of the mark, as well as for the comfort and health of the animal.

In view of this requirement, loops were proposed that comprise aeration holes at the top. For example, FR 2 550 915 describes an identification loop that comprises a protective cap that is to be broken for disengaging the male part from the female part. This cap can have a small aeration hole so as to increase the hygiene performance levels of the loop. The application FR 2 818 091 describes a tag that is designed to limit fraud while preserving a reduced risk of infection, in which the female part comprises a coaxial hollow projection with a hole that receives the male part, comprising—at its free end—tenons that delimit the openings with reduced dimensions that make it possible to preserve air circulation.

However, the size of these openings, which is reduced because of the emphasis placed on the fight against fraud, is not of the type to provide significant enhancement of healing at the insertion point. In addition, even if the loops are designed such that the rod pivots freely in the receiving button, the space that is provided between the parts is very thin so as to ensure their irreversible locking. Actually, the play provided between the male rod and the female button allows only a pivoting of the parts between one another in keeping them flattened on both sides of the ear to prevent objects such as iron filings, string, or branches from becoming hooked therein and causing detachment. As a result, the part of the loop that is open to the outside is separated from the animal's ear by the locking device. The surface of the loop that is in contact with the ear therefore constitutes a confined zone that is not very conducive to the drying of tissue and rapid healing.

However, in accordance with the European Directive 1760/2000, all animals should wear two loops permanently, so that even in the case of loss or deterioration of one tag, the monitoring of the marking is ensured. As a result, the costs and time dedicated to marking and replacing lost or damaged tags, as well as the monitoring and care provided to the animals after the affixing of the tags, has increased significantly, which involves a significant effort for farmers. The use of ear tags making possible a correct affixing of the loops added to a quick and complete healing now appears to be a sanitary and economic necessity.

The invention eliminates this problem by proposing an ear marking loop for livestock that comprises openings according to a shaping that makes possible circulation of air in the immediate proximity of the piercing zone and that ensures continuous ventilation that promotes the healing of the ear. By selecting a marking technique that takes into consideration risks of infection and formation of abscesses, the state of health in farming is improved and at the same time the risks of suffering are reduced for the animals.

More specifically, this invention has as its object an ear loop for marking and identifying livestock, combining—with a male part—a female part that consists of a button that has a channel and a cavity for receiving the male part, whereby said button comprises an essentially cylindrical or tapered top and a circular surface extending in a plane that is essentially perpendicular to the axis of the top from the base of the latter, whereby said loop is characterized in that the surface of the receiving button comprises at least two perforations that connect the lower face of the surface to the atmosphere.

The ear tag according to the invention is of the type that primarily combines a male part and a female part according to any method that is known in the art. The male part can comprise, for example, a rod that is terminated by a point, whereby the female part consists of a receiving button that has a channel and a cavity for the insertion of the point of the rod, the channel that empties into the cavity by forming a shoulder for holding the point after its insertion. In general, the respective diameters of the channel and the cavity are such that the rod pivots freely in the female part. The male part can thus be attached to the female part by irreversible interlocking using a clamp that first makes it possible to pierce the animal's ear and then to embed the point of the rod into the receiving button. The loops are usually produced from molded plastic material but can also be made of aluminum, brass, or steel.

The button, formed by the top and a circular surface, resembles in its general outline a brimmed hat, whereby this comparison does not address its internal structure. In a known manner, the top of the button assumes an essentially cylindrical or tapered shape, whereby its base can be wider than its top, which softens its shape and enhances its solidity. The circular surface is flat overall with a rounded edge so as not to cause injuries. It is in a plane that is essentially perpendicular to the axis of the top, such that when the loop is installed in the animal's ear, said surface comes to rest against the ear over its entire surface, preventing the withdrawal of the loop. Another essential operation of this surface is to carry one or more identification codes of the animal.

Although this invention is particularly suited to ear buttons whose circular surface is used for the inscription or the insertion of a code, secondarily and in a known manner, the loop can be supplemented by a small plate that acts as a tag.

According to the invention, at least two perforations are made on the surface of the receiving button so as to connect the inside face of the surface, and thus the surface of the ear located under the loop, to the atmosphere. These openings can take on any geometry provided that the entire surface is covered. They can have, for example, a cross-section that is round, square, trapezoidal, in an arc, etc., with a uniform or tapered size and conveniently pass through the surface at a right angle, or on a slant, if desired. They ensure an aeration of the ear under the button and promote healthy development of the insertion point of the male rod.

According to a preferred characteristic, the circular surface of the auricular loop according to the invention comprises at least four perforations, and preferably also at least six perforations. Maximum aeration of the healing zone is actually desired.

According to an advantageous characteristic of the ear loop that is the object of the invention, the perforations are distributed at regular intervals over the circular surface. The vulnerability points that are linked to too great a proximity of the perforations that could lead to the creation of a breaking line are thus limited.

According to another advantageous characteristic of the invention, the perforations are made perpendicular to the base of the top. In this way, the orifices are arranged close to the healing zone that ensures optimal aeration for it.

According to an advantageous embodiment, the perforations have an opening that extends radially over approximately one third of the surface starting from the base of the top. In this way, a good compromise between effectiveness of aeration and sturdiness of the circular surface of the loop is obtained.

Preferably, the openings of the perforations have a cumulative surface of at least 3% relative to the surface of the lower face of the surface, designed to be in contact with the animal's ear. In a particularly preferred manner, said orifices occupy at least 5% of the contact area between the surface and the animal's ear. It has actually been noted that one size of the perforations offering an exchange surface with the atmospheric air on the order of at least 3% makes it possible to obtain a satisfactory drying of the surface of the ear under the surface and proper healing around the rod of the male part. Optimum results of around 5% of exchange surface are obtained since for higher values, there is the danger of cases of deterioration that would jeopardize the effectiveness of the device.

To also improve the aeration of the ear zone that is confined under the loop, other openings can be provided at the top. Thus, in the ear loop according to the invention, the top of the button can comprise at least one opening that puts the cavity in direct connection with the outside atmosphere.

Said opening can assume the shape of a slot. According to one preferred characteristic of the ear loop according to the invention, the top comprises two or three equidistant slots that are oriented parallel to the axis of the top.

These slots are made in the wall of the top of the button that separates the receiving cavity from the atmosphere. An opening that is elongated and of small width makes it possible to preserve the rigidity of the tag, which must be preserved at all times, while offering proper airing. It is well understood that these openings are separate from the channel that accommodates the male rod, which is in no way in direct connection to the atmosphere but on the contrary is in contact with the tissues of the animal's ear. Using these openings, the atmospheric air can circulate via the cavity and the orifice of the button up to the zone for piercing the ear and can prevent the accumulation of liquids, oozing from the wound just as from the skin, by allowing them to flow and/or to evaporate.

According to one advantageous characteristic of the ear loop according to the invention, the inside wall of the top of the button has a recess that is close to each of said slots so as to increase the volume of air that is present in the cavity.

A simple reduction of the thickness of the wall of the top of the button on both sides of the slots is a simple and effective means for creating such a recess.

According to an advantageous embodiment of the ear loop according to the invention, said button consists of two shells that are assembled on one another and comprising the same number of perforations that are placed at the same location on the circular surface. The perforations should therefore be made before assembling the two shells, which, given the reduced size of the loops and the precision required so that the orifices coincide exactly, involves having recourse to advanced technologies to correctly position the two half-shells, one relative to the other, without the production costs reaching prohibitive levels. With a manual assembly being excluded for economic reasons, so-called industrial vision techniques can be usefully implemented here.

In any case, it is recommended that the surfaces placed opposite assume a complementary shape that promotes their contact. Actually, the contact zone between the upper and lower shells makes it possible to attach them together, for example by bonding or by welding via ultrasound. Any other assembly means, such as clamping, can also be used if it meets the imperatives of required solidity and precision.

According to an alternative embodiment of the ear loop according to the invention, the button consists of an integrally molded single part.

In an advantageous embodiment of the ear loop according to the invention, the circular surface also comprises means for supporting an identification code of an animal. All of the legal data can be inscribed there by printing, engraving, bar code or any other means that is known to one skilled in the art, making possible the identification of the animal. The support means of a code can also consist in electronic identification means, such as an electronic transponder (called RFID) that is housed, for example, in a space that is provided for this purpose between the two shells that constitute the female part or obtained by molding from a casting in this part.

Thus, thanks to the marking device according to the invention that comprises one or more openings at different levels of the attachment button, good aeration of the wound made in the animal's ear by a punch of the male part passing through is promoted without weakening the rigidity and sturdiness of the button and without allowing the expulsion by force of the male part or any other manipulation whose purpose is to falsify the data contained in the loop.

This invention will be better understood, and details revealing it will be provided, based on the description that will be given, in different embodiments, in connection with the figures of the accompanying sheets, in which:

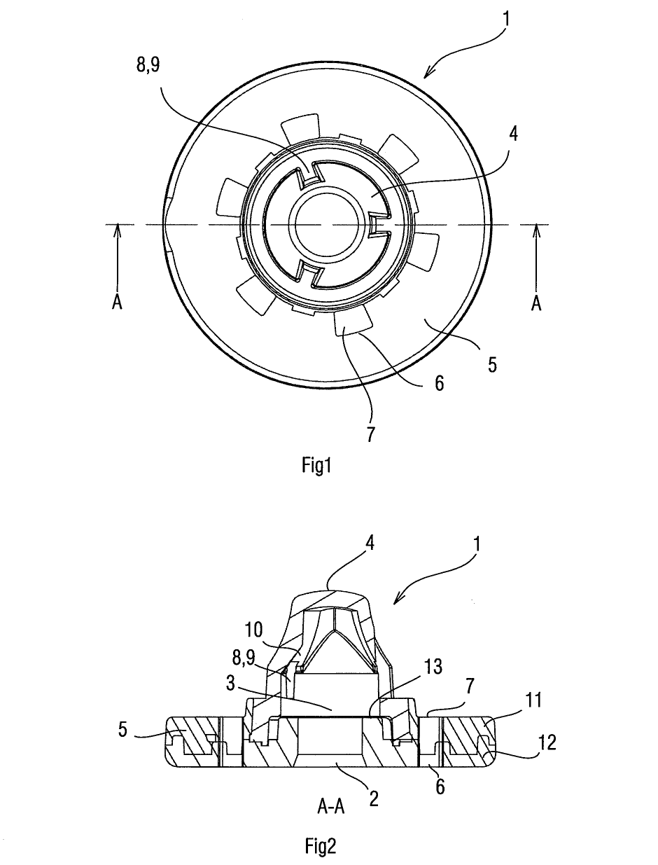

FIG. 1 is a top view of the female part of an ear button according to the invention;

FIG. 2 exhibits a cutaway view of the female part of an ear button according to the invention.

The examples that are illustrated here are produced from known types of ear buttons by providing them with the modifications according to the invention.

FIGS. 1 and 2 show the female part of an ear loop that is designed for the identification and the marking of an animal. A loop will be formed by combining this female part and a male part (not shown), which comprises a rod and a point, by irreversible interlocking The female part comprises the button 1 in which the channel 2 and the cavity 3 are made.

During the installation of the ear loop by an operator, the point passes through the animal's ear, and then it engages in the channel 2 for penetrating into the cavity 3 of the button 1. Once the loop is affixed, the point is housed in the cavity 3 and is held there by the holding shoulder 13 that carries out the transition between the cavity 3 and the channel 2. The diameter of the point is slightly less than that of the cavity 3, and likewise the diameter of the rod 3 is slightly less than that of the channel 2, such that the male part and the female part can carry out rotational movements relative to one another.

The top 4 of the button 1 assumes a tapered shape, whereby its base is wider than its top. The generally flat circular surface 5 extends from the base of the top 4 in a plane that is perpendicular to the axis of the latter. It comprises six perforations 6 that connect the inside face of the surface 5—and therefore the surface of the ear that is under the loop—to the atmosphere. The perforations 6 have a trapezoidal section and a uniform size within the entire thickness of the surface 5 that they pass through at a right angle. They are distributed at regular intervals perpendicular to the base of the top 4. They extend radially over approximately one third of the surface 5 starting from the base of the top 4, such that they occupy approximately 5% of the contact area between the surface 5 and the animal's ear.

The button 1 consists of two shells 11, 12 that are assembled on one another and that comprise the same number of perforations 6 that are placed at the same location on the circular surface 5 and are positioned correctly relative to one another at the time of assembly, so that the perforations coincide exactly. The surface 5 can comprise means of identification, such as, for example, a small marking plate (not shown here), engraving, or an RFID transponder that is housed between the shells 11 and 12.

In the embodiment that is presented here, several openings 8 are made in the wall of the top 4 of the button 1 that separates the receiving cavity 3 from the atmosphere. These openings assume the shape of three slots 9 that are oriented axially and distributed in an equidistant manner. The inside wall of the top 4 of the button 1 has the recess 10 that is close to each of the slots 9, whereby said recess is created by a reduced thickness of the wall of the button 4 on both sides of the slots 9.

The different openings that are described, made in the top 4 and the surface 5 of the button 1, put the animal's ear in direct connection with the outside atmosphere. The other geometric or physical characteristics of the marking ear loop remain as implemented in the prior known embodiments, of which some have been described in detail, in particular in the patents of the applicant (see, for example, the French patents FR 2 879 399 and FR 2 845 564, or the application FR 05 10448).

If the present amendment is a preliminary amendment filed in the National Stage of a PCT application, the US DO/EO is directed NOT to enter any claim amendment made under Article 19 or Article 34 during prosecution of the International Stage of this application.

1-13. (canceled)

14. Ear loop for marking and identifying livestock, combining—with a male part—a female part that consists of a button (1) that has a channel (2) and a cavity (3) for receiving the male part, whereby said button comprises an essentially cylindrical or tapered top (4) and a circular surface (5) that extends in a plane that is essentially perpendicular to the axis of the top from the base of the latter, whereby the loop is characterized in that the surface (5) of the receiving button (1) comprises at least two perforations (6) that are made perpendicular to the base of the top (4), connecting the lower face of said surface to the atmosphere.

15. Ear loop according to claim 14, wherein the circular surface (5) comprises at least four perforations (6), and preferably at least six perforations (6).

16. Ear loop according to claim 14, wherein the perforations (6) are distributed at regular intervals over the circular surface (5).

17. Ear loop according to claim 14, wherein the perforations (6) have an orifice (7) that extends radially over approximately one third of the surface (5) starting from the base of the top (4).

18. Ear loop according to claim 14, wherein the orifices (7) of the perforations (6) have a cumulative surface of at least 3%, and preferably at least 5%, relative to the surface of the lower face of the surface (5) that is designed to be in contact with the animal's ear.

19. Ear loop according to claim 14, wherein the top (4) of the button (1) also comprises at least one opening (8) that puts the cavity (3) in direct connection to the outside atmosphere.

20. Ear loop according to claim 19, wherein the top (4) of the button (1) comprises two or three equidistant slots (9) that are oriented parallel to the axis of the top (4).

21. Ear loop according to claim 20, wherein the inside wall of the top (4) of the button (1) has a recess (10) that is close to each of said slots so as to increase the volume of air that is present in the cavity.

22. Ear loop according to claim 14, wherein the button (1) consists of two shells (11, 12) that are assembled on one another and that comprise the same number of perforations (6) placed at the same locations on the circular surface (5).

23. Ear loop according to claim 14, wherein the button (1) consists of an integrally molded single part.

24. Ear loop according to claim 14, wherein the circular surface (5) also comprises means for support of an identification code of an animal.

25. Ear loop according to claim 14, wherein it contains an electronic transponder (RFID).
